(19) United States
(12) Patent Application Publication
(10) Pub. No.: US 2015/0248527 A1
(43) Pub. Date: Sep. 3, 2015

(54) PROMPTING MEDICATION SAFETY TECHNOLOGY

(71) Applicant: International Business Machines Corporation, Armonk, NY (US)

(72) Inventors: Feng Cao, Shanghai (CN); Yuan Ni, Shanghai (CN); Xiao Yuan Wang, Shanghai (CN); Hui Jia Zhu, Shanghai (CN)

(73) Assignee: International Business Machines Corporation, Armonk, NY (US)

(21) Appl. No.: 14/194,967

(22) Filed: Mar. 3, 2014

(51) Int. Cl. G06F 19/00

(52) U.S. Cl. CPC G06F 19/326

(57) ABSTRACT

Method, apparatus, and hospital information system for prompting medication safety. The method includes: extracting identifier information and execution time of a prescribed drug from a treatment information database; according to the identifier information of the drug, extracting a record related to the drug from an information database; for each contributor factor of the prescribed drug, determining an unsafe time interval corresponding to the contributor factor of the drug; extracting identifier information and execution time of a target factor from the treatment information database; and, in response to the target factor matching with a contributor factor of the drug and at least a part of the execution time of the target factor falling within the unsafe time interval corresponding to the matched contributor factor, prompting medication safety in the complete drug taking lifetime. Through adopting the present invention, internal data process can be optimized and medication safety can be improved.

### BACKGROUND OF THE INVENTION

The present invention relates to the field of information processing. More specifically, the present invention relates to a method, apparatus, and hospital information system for prompting medication safety information.

In general, an Electronic Health Record (EHR) system includes an electronic health record database and a client terminal used by a doctor. When a prescription or therapeutic schedule is given by a doctor, the prescription or therapeutic schedule can be inputted into the client terminal. The client terminal can send the information to the electronic health record database. In the electronic health record database, history data of all prescriptions and therapeutic schedules are stored according to users. When a patient goes to a hospital next time, a patient ID is inputted to the client terminal. The client terminal can send the patient ID to the electronic health record database. All prescriptions and therapeutic schedules of the patient can be fetched out according to the patient ID from the electronic health record database and the searched results are returned to the client terminal for display so that a doctor can give a comprehensive diagnosis based on the displayed results.

However, such a system has poor utilization of information. For example, medication safety has become an increasingly serious issue for public health. In fact, in the previous prescriptions and therapeutic schedules of a patient, there can be some adverse drug event (ADE) information, which is extremely critical for medication safety. In the prior art, there is a lack of a following mechanism in technique practices, which can associate a treatment information database with a drug information database in a comprehensive manner, so that the real-time mining and provision of some important information (such as drug information) can be realized based on the database organizing, associating, and dynamical accessing techniques.

In other words, database information has low utilization and poor information retrieving efficiency because dynamical database organizing, associating, and accessing cannot be achieved in the prior art. For example, when medication safety is considered, the effects of some treatment information on subsequent treatments tend to be ignored or mutual effects that can be produced by future treatments (such as drugs to be taken) on past treatments are not even unknown, resulting in low efficiency of providing correct information, poor comprehensiveness, slow process speed of information retrieving, and more processing resources consumed for information acquisition.

### SUMMARY OF THE INVENTION

A problem to be addressed in an embodiment of the present invention is to provide a method, apparatus, and hospital information system for prompting medication safety which are capable of increasing the processing speed of a system for obtaining associated medication safety information and of improving the efficiency and comprehensiveness of safety information association and process.

According to one embodiment of the present invention, there is provided a method for prompting medication safety, including: extracting identifier information and execution time of a prescribed drug from a treatment information database for storing treatment information; according to the identifier information of the prescribed drug, extracting a record related to the prescribed drug from a drug information database for storing drug information, the record including at least one contributor factor of the prescribed drug and unsafety information corresponding to the at least one contributor factor; for each of the at least one contributor factor of the prescribed drug, according to the execution time of the prescribed drug and the unsafety information corresponding to the contributor factor, determining an unsafe time interval corresponding to the contributor factor of the prescribed drug; extracting identifier information and execution time of a target factor from the treatment information database; and in response to the target factor matching with a contributor factor of the prescribed drug and at least a part of the execution time of the target factor falling within the unsafe time interval corresponding to the matched contributor factor, prompting medication safety.

According to another embodiment of the present invention, there is provided an apparatus for prompting medication safety, including: a first extraction component configured to extract identifier information and execution time of a prescribed drug from a treatment information database for storing treatment information; a second extraction component configured to, according to the identifier information of the prescribed drug, extract a record related to the prescribed drug from a drug information database for storing drug information, the record including at least one contributor factor of the prescribed drug and unsafety information corresponding to the at least one contributor factor; a determination component configured to, for each of the at least one contributor factor of the prescribed drug, according to the execution time of the prescribed drug and the unsafety information corresponding to the contributor factor, determine an unsafe time interval corresponding to the contributor factor of the prescribed drug; a third extraction component configured to extract identifier information and execution time of a target factor from the treatment information database; and a prompting component, configured to, in response to the target factor matching with a contributor factor of the prescribed drug and at least a part of the execution time of the target factor falling within the unsafe time interval corresponding to the matched contributor factor, prompt medication safety.

According to another embodiment of the present invention, there is provided a hospital information system including the above apparatus.

According to the above technical solutions, through adopting the treatment information database and the drug information database in an associated manner and by means of dynamical search and association techniques, internal data process can be optimized and system process efficiency and comprehensiveness of finding out prescribed drugs for a patient and determining respective unsafe temporal intervals corresponding to the prescribed drugs to recognize effects produced by the prescribed drugs can be improved, so that system process speed for obtaining associated medication safety information can be greatly increased and system processing resources can be saved.

### BRIEF DESCRIPTION OF THE DRAWINGS

Through the more detailed description of some embodiments of the present invention in the accompanying drawings, the above and other objects, features, and advantages of the present invention are made more apparent. The same reference generally refers to the same components in the embodiments of the present invention.

FIG. 1 shows an exemplary computer system/server 12 which is applicable to implement the embodiments of the present invention.

FIG. 2 shows a flowchart of a method for prompting medication safety according to an embodiment of the present invention.

FIG. 3 shows a flowchart of another method for prompting medication safety according to an embodiment of the present invention.

FIG. 4 shows an example of a table stored in a treatment information database according to an embodiment of the present invention.

FIG. 5 shows an example of a table stored in a drug information database according to an embodiment of the present invention.

FIG. 6 shows an example of a table stored in a drug use database, which is obtained by using the tables shown in FIG. 4 and FIG. 5 with the method according to an embodiment of the present invention.

FIG. 7 shows a structural block diagram of an apparatus for prompting medication safety according to an embodiment of the present invention.

FIG. 8 shows a structural block diagram of another apparatus for prompting medication safety according to an embodiment of the present invention.

FIG. 9 shows a structural block diagram of a hospital information system according to an embodiment of the present invention.

### DETAILED DESCRIPTION OF THE PREFERRED EMBODIMENT

Some preferable embodiments are described in more detail with reference to the accompanying drawings, in which the preferable embodiments of the present invention have been illustrated. However, the present invention can be implemented in various manners and, thus, should not be construed to be limited to the embodiments disclosed herein. On the contrary, these embodiments are provided for the thorough and complete understanding of the present invention and to convey the scope of the present invention to those skilled in the art.

As can be appreciated by one skilled in the art, aspects of the present invention can be embodied as a system, method, or computer program product. Accordingly, aspects of the present invention can take the form of an entirely hardware embodiment, an entirely software embodiment (including firmware, resident software, micro-code, etc.), or an embodiment combining software and hardware aspects that can all generally be referred to herein as a “circuit,” “module” or “system.” Furthermore, aspects of the present invention can take the form of a computer program product embodied in one or more computer readable medium(s) having computer readable program code embodied thereon.

Any combination of one or more computer readable medium(s) can be utilized. The computer readable medium can be a computer readable signal medium or a computer readable storage medium. A computer readable storage medium can be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium can include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium can be any tangible medium that can contain or store a program for use by or in connection with an instruction execution system, apparatus, or device.

A computer readable signal medium can include a propagated data signal with computer readable program code embodied therein, for example, in baseband or as part of a carrier wave. Such a propagated signal can take any of a variety of forms, including, but not limited to, electro-magnetic, optical, or any suitable combination thereof. A computer readable signal medium can be any computer readable medium that is not a computer readable storage medium and that can communicate, propagate, or transport a program for use by or in connection with an instruction execution system, apparatus, or device.

Program code embodied on a computer readable medium can be transmitted using any appropriate medium, including but not limited to wireless, wireline, optical fiber cable, RF, etc., or any suitable combination of the foregoing.

Computer program code for carrying out operations for aspects of the present invention can be written in any combination of one or more programming languages, including an object oriented programming language, such as Java, Smalltalk, C++ or similar programming languages and conventional procedural programming languages, such as the “C” programming language or similar programming languages. The program code can execute entirely on the user's computer, partly on the user's computer, as a stand-alone software package, partly on the user's computer and partly on a remote computer, or entirely on the remote computer or server. In the latter scenario, the remote computer can be connected to the user's computer through any type of network, including a local area network (LAN) or a wide area network (WAN), or the connection can be made to an external computer (for example, through the Internet using an Internet Service Provider).

Aspects of the present invention are described below with reference to flowchart illustrations and/or block diagrams of methods, apparatuses (systems), and computer program products according to embodiments of the present invention. It is understood that each block of the flowchart illustrations and/or block diagrams and combinations of blocks in the flowchart illustrations and/or block diagrams can be implemented by computer program instructions. These computer program instructions can be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions can also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions can also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

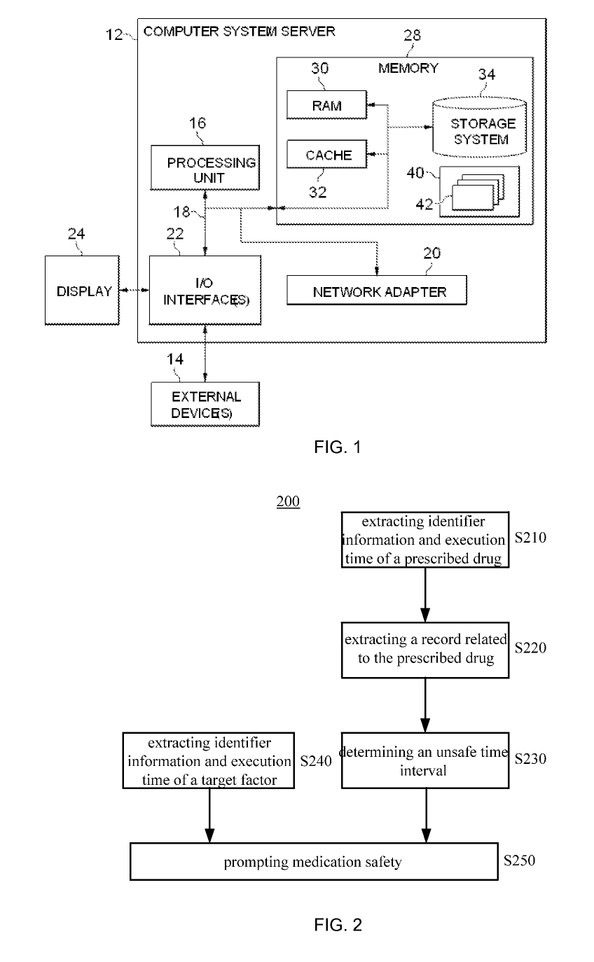

Referring now to FIG. 1, FIG. 1 is an exemplary computer system/server 12 which is applicable to implement the embodiments of the present invention. Computer system/server 12 is only illustrative and is not intended to suggest any limitation as to the scope of use or functionality of embodiments of the present invention described herein.

As shown in FIG. 1, computer system/server 12 is shown in the form of a general-purpose computing device. The components of computer system/server 12 can include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer system/server 12 typically includes a variety of computer system readable media. Such media can be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 can further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”) and an optical disk drive for reading from or writing to a removable, non-volatile optical disk such as a CD-ROM, DVD-ROM, or other optical media can be provided. In such instances, each can be connected to bus 18 by one or more data media interfaces. As can be further depicted and described below, memory 28 can include at least one program product having a set (e.g., at least one) of program modules that are configured to carry out the functions of the embodiments of the present invention.

Program/utility 40, having a set (at least one) of program modules 42, can be stored in memory 28 by way of example, and not limitation, as well as an operating system, one or more application programs, other program modules, and program data. Each of the operating systems, one or more application programs, other program modules, and program data or some combination thereof, can include an implementation of a networking environment. Program modules 42 generally carry out the functions and/or methodologies of embodiments of the present invention as described herein.

Computer system/server 12 can also communicate with one or more external devices 14 such as a keyboard, a pointing device, a display 24, etc., one or more devices that enable a user to interact with computer system/server 12, and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It is understood that, although not shown, other hardware and/or software components can be used in conjunction with computer system/server 12. Examples include, but are not limited to, microcodes, device drivers, redundant processing units, external disk drive arrays, RAID systems, tape drives, data archival storage systems, etc.

With reference now to FIG. 2, FIG. 2 is a flowchart of a method 200 for prompting medication safety according to an embodiment of the present invention.

As shown in FIG. 2, the method 200 includes: at S210, extracting identifier information and execution time of a prescribed drug from a treatment information database for storing treatment information; at S220, according to the identifier information of the prescribed drug, extracting a record relevant to the prescribed drug from a drug information database for storing drug information, the record including at least one contributor factor of the prescribed drug and unsafe information corresponding to the at least one contributor factor; at S230, for each of the at least one contributor factors of the prescribed drug, according to the execution time of the prescribed drug and the unsafe information corresponding to the contributor factor, determining an unsafe temporal interval of the prescribed drug corresponding to the contributor factor; at S240, extracting identifier information and execution time of a target factor from the treatment information database; and at S250, in response to the identifier information of the target factor matching with a contributor factor of the prescribed drug and at least part of the execution time of the target factor falling within the unsafe temporal interval corresponding to the matched contributor factor, prompting medication safety.

According to an embodiment of the present invention, the treatment information database can be an EHR database, an ENR database, or any other database that can store treatment information of patients. The treatment information of a patient at least includes prescription information about prescriptions that have been given to the patient and can further include clinical operation information, such as medical examinations and/or operations that have been taken for the patient.

The prescription information can include identifier information of a drug and execution time of the drug. The drug can be uniquely identified by the identifier information of the drug, such as the name, code, number, trademark of the drug, and so on. The execution time of the drug can indicate a period of time during which the drug is used. For example, the execution time of the drug can include a time when the drug is prescribed by a doctor, a beginning time when the drug is taken (a drug taking beginning time), an ending time when the drug is finished being taken (a drug taking ending time), how long the drug is taken, and so on. In some embodiments of the present invention, if the prescription information only includes the time when the drug is prescribed without the drug taking beginning time, the time when the drug is prescribed is treated as the drug taking beginning time. The drug taking beginning time and the drug taking ending time can be determined from the execution time of the drug.

Similarly, the clinical operation information can include identifier information of a clinical operation and execution time of the clinical operation. The clinical operation can be uniquely identified by the identifier information of the clinical operation, such as the name (for example, heart bypass operation, hemodialysis, etc.), number, code of the clinical operation, and so on. The execution time of the clinical operation can indicate the time when the clinical operation is to be executed, for example, an action beginning time and an action ending time. In general, because a clinical operation has a duration period not longer than one day, the execution time of the clinical operation is generally within a certain day, which is not only the action beginning time but also the action ending time of the clinical operation.

FIG. 4 shows an example of a treatment information database according to an embodiment of the present invention. Treatment information about a patient (hereinafter, patient X) is stored in a table 400 stored in the treatment information database. This treatment information can include all prescription information and/or clinical operation information prescribed for patient X since patient X sought medical advice for the first time. This information can further include prescription information and/or clinical operation information to be prescribed for patient X. Different records in the table can be produced by different doctors at different consulting hours or different records can be added by patient X based on his own treatment information using an application interfaced to the treatment information database.

In an embodiment of the present invention, as shown in FIG. 4, the table 400 can include a timestamp field, a therapy factor field, and an effective duration field. The timestamp field can represent the beginning time of a drug or a clinical operation involved in the therapy factor field. The therapy factor field can represent identifier information of prescribed drugs and/or drugs to be prescribed for the patient by doctors and identifier information of clinical operations. Through comparing a time present in the timestamp field with the current time, it can be determined whether the content in the therapy factor field has been initiated or is to be executed. The effective duration field can represent the duration of a drug or a clinical operation. These fields are merely an example, and are not intended to limit the scope of the present invention. For example, the timestamp field and the effective duration field can be combined to an execution time field. Also, the table 400 can further include other fields, such as a comment field or a field about whether a further consultation is required.

The target factor can be content stored in the therapy factor field. The target factor is defined as a drug or a clinical operation that has been present or is to be present in prescription information in the treatment information database. Thus, a prescribed drug is necessarily a target factor, but a target factor is not necessarily a prescribed drug and can include any one of an allergy factor, a disease factor, a medication factor, a clinical operation factor, and a population factor. That is to say, a target factor is a drug or a clinical operation for which it is necessary to determine whether there is any ADE (adverse drug event) produced with a drug that has been taken. For example, when a doctor needs to prescribe an additional drug B for patient X (or perform an additional surgery), the doctor may need to determine whether drug B (or the surgery) can lead to an ADE with a drug that has been taken and/or a clinical operation that has been experienced or is to be experienced by the patient X and in such a case, drug B (or the surgery) is the target factor.

As shown in FIG. 4, there are three records stored in the table 400. The first two are clinical events that have already occurred and the last one is a clinical event to be occurred. The first record represents that a doctor has prescribed drug A for patient X and instructed patient X to take drug A for 2 months since Jun. 15, 2012. The second record represents that a doctor arranged for patient X to have a hemodialysis treatment on Jul. 20, 2012. The third record represents that a doctor intends to prescribe drug B for patient X and instruct patient X to take drug B for three weeks since Aug. 5, 2012. Obviously, these records are merely an example, which is provided for a better understanding of the present invention.

In addition to the treatment information database, the drug information database for storing drug information is further required in method 200. The drug information can include identifier information of a drug, contributor factors of the drug, unsafe information corresponding to those contributor factors, etc. The identifier information of the drug has been described as above. The contributor factor of the drug indicates that taking the drug can lead to an Adverse Drug Event (ADE) under the influence of the contributor factor. For example, if drug A is contraindicated to lactating women, myocardial infarction patients, and those who are allergic to composition C, then, “ lactating women”, “myocardial infarction” and “composition C” are contributor factors of drug A, respectively. As another example, if drug B is not allowed to be taken within one month after taking drug A, “drug B” is a contributor factor of drug A. As a further example, if drug A is not allowed to be taken within one week before a hemodialysis treatment, “hemodialysis” is a contributor factor of drug A. Unsafe information corresponding to a contributor factor is used to indicate a condition under which an ADE resulted from the contributor factor and a drug occurs.

With the above examples, “currently being”, “previously suffering”, “previously suffering”, “one month after the taking of drug A”, and “one week before a hemodialysis treatment” are unsafe information of the contributor factors “lactating women”, “myocardial infarction”, “composition C”, “drug B”, and “hemodialysis”, respectively. If such unsafe information is violated during the use of a drug, ADEs can occur. Unsafe information can be extracted from drug specifications directly, can be found out through searching a database for storing empirical data, or can be inputted into the drug information database directly. The empirical data in the database is used to represent conditions under which ADEs occur and can be obtained from professional books, papers, web pages, and so on through content mining or can be obtained by inputting information by professional persons.

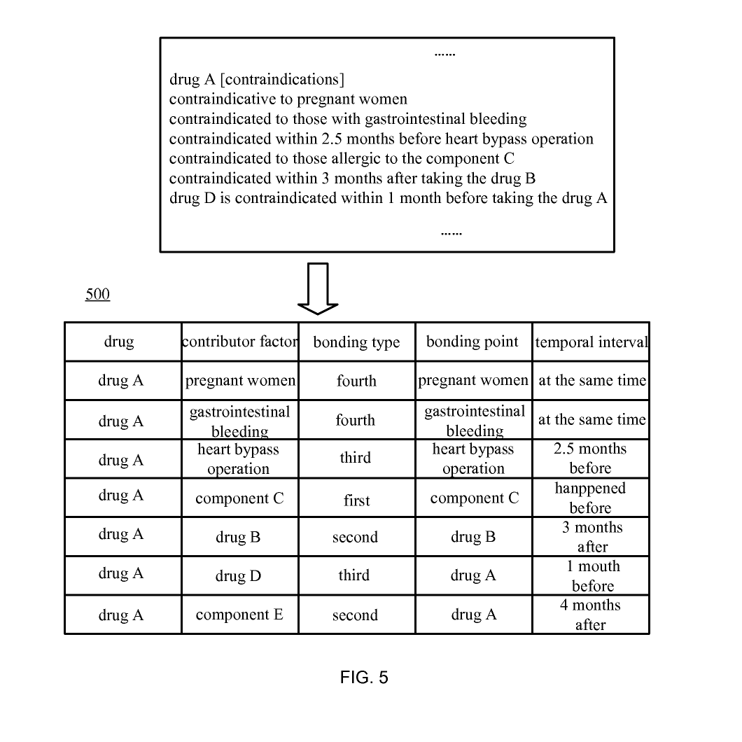

FIG. 5 shows an example of the drug information database. A table 500 stored in the drug information database can be obtained based on the specification of drug A shown above the table 500 in FIG. 5. A pre-process performed on the drug specification described hereinafter can be used to obtain the table 500 according to the drug specification. It is a matter of course that table 500 can be obtained through information entering. Obviously, by performing the pre-process on the drug specification, records in the drug information database can be automatically produced in an easy and efficient manner. Further, the drug information database can be expanded continuously according to new drug specifications and, thus, more complete and comprehensive information is acquired. Compared to the prior art in which ADE knowledge is only for reading, ADE knowledge can be exploited in two directions. In addition, tedious and low efficient information entering can be avoided and errors caused by information entering can be prevented.

The table 500 can include a drug field, a contributor factor field, a binding type field, a binding point field, and a time interval field. The drug field can be used to represent identifier information of a drug as described above. The contributor factor field can be used to represent identifier information of a contributor factor which can cause an ADE with the drug (for example, the name, code, number of the contributor factor, and so on). Unsafe information between a drug and a contributor factor can be determined by means of the binding type field, the binding point field, and the time interval field. The binding type field can indicate the type of a condition under which an ADE between a drug and a contributor factor can occur. According to an embodiment of the present invention, there are four binding types between drugs and contributor factors, which are described later. The binding point field can represent that the interval indicated in the time interval field is related to which one of the drug and the contributor factor (i.e., the interval indicated in the time interval field is started from which one of the drug and the contributor factor). The interval indicated in the time interval field is an interval during which an ADE can be caused by the drug and the contributor factor. In other words, that is an interval during which the drug and the contributor factor should not happen concurrently. The table 500 is described in detail below with an example. In addition to the fields mentioned above, the table 500 can further include other fields such as a comment field, a dose information field, etc.

Although the storage of drug information is described in FIG. 5, taking drug A as an example, drug information of more drugs (even all drugs that have been known or available from hospitals) can be stored in the drug information database and the drug information of each drug can be stored in a manner similar to that of drug A.

When the content of the treatment information database and the content of the drug information database are combined with each other, through jointly processing the execution time of a drug (such as the time when taking the drug) with the contributor factors and unsafe information of the drug, a special unsafe time interval related to the drug under the influence of its certain contributor factor can be obtained. If a target factor acting as the certain contributor factor happens in the obtained unsafe time interval, the target factor can cause an ADE, which can be injurious to patient health or even lead to diseases. Thus, in such a situation, it is desired to prompt medication safety to avoid the occurrence of the ADE.

In the method 200, there is no limitation on the execution order of S240 and S210 to S230, so long as S240 is executed before S250.

According to the above method for prompting medication safety, by utilizing the treatment information database in conjunction with the drug information database, internal data processing can be optimized, prescribed drugs can be found out thoroughly for a patient, and respective unsafe time intervals corresponding to those prescribed drugs can be determined so that the influence of the prescribed drugs can be determined completely and efficiently. By comparing the execution time of a target factor with the unsafe time intervals, a patient can be prevented from performing events which can cause ADEs within the unsafe time intervals and, thus, medication safety can be improved.

Records stored in the drug information database are required for obtaining unsafe time intervals. According to an embodiment of the present invention, at least one contributor factor of a drug and unsafe information corresponding to the at least one contributor factor of the drug can be obtained by pre-processing a drug specification of the drug. After that, for each contributor factor, a record of the drug related to the contributor factor can be formed from the identifier information of the drug, the contributor factor of the drug, and unsafe information corresponding to the contributor factor and is stored in the drug information database.

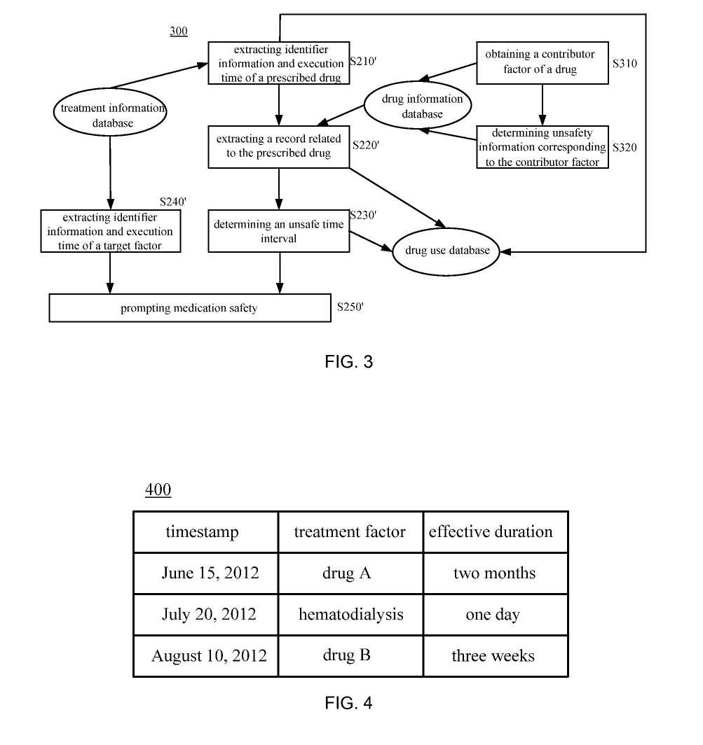

Below, in connection to a method 300 of FIG. 3, another method for prompting medication safety according to an embodiment of the present invention is described in detail. As described above, the treatment information database and the drug information database are used in the method for prompting medication safety. First of all, how to obtain the drug information database through S310 and S320 is described.

At S310, according to predefined contributor factor templates, at least one contributor factor of a drug is obtained from the drug specification. The contributor factor templates can include at least one of an allergy factor template, a disease factor template, a medication factor template, a clinical operation factor template, and a population factor template.

The contributor factor template refers to a model, parameter or function, by which a contributor factor can be extracted. For example, because the drug specification can be in an electronic form conforming to a specific data structure, templates for extracting contributor factors can be established by using special characters or specific codes representing contributor factors in the data structure. Alternatively, even if the drug specification is not in an electronic form, it can be converted into an electronic version with conventional techniques, such as electronic scanning, text recognition, and the like. A model for extracting a contributor factor can be established based on the occurrence rule (pattern) of the contributor factor in the text. By applying the contributor factor templates to the drug specification in an electronic form (for example, by matching with the templates), a corresponding contributor factor can be found out. For instance, template matching can be realized by keyword search, character pattern similarity calculation, and other existing ways for searching related contents with template matching that can occur to those skilled in the art.

The allergy factor template, the disease factor template, the medication factor template, the clinical operation factor template, and the population factor templates contained in the contributor factor templates can be used for extracting an allergy factor, a disease factor, a medication factor, a clinical operation factor, and a population factor, respectively.

The allergy factor refers to a substance which can cause hypersensitivity reactions incurred by a person's immune system. Such a substance is normally harmless, but can cause a hypersensitivity phenomenon for someone due to individual differences. For example, as for “the drug A is contraindicated for persons allergic to the component C”, the “component C” is the allergy factor of drug A.

The disease factor refers to an element that can cause abnormal conditions of a human body or an organism, including diseases in the normal sense as well as medical symptoms, signs, and the like. For example, as for “the drug A is contraindicated for those suffering gastrointestinal bleeding”, the “gastrointestinal bleeding” is the disease factor of drug A.

The medication factor refers to a medication used by humans, including an oral medication, an injectable medication, a medication for external use, etc. For example, as for “the drug D cannot be used within one month before taking the drug A”, “drug D” is the medication factor of drug A.

The clinical operation factor refers to a clinical operation, a physical examination, a dialysis treatment, a chemotherapy treatment and so on applied on human bodies. For example, as for “the drug A cannot be used within two months before a heart bypass operation”, the “heart bypass operation” is the clinical operation factor of drug A.

The population factor refers to a common feature shared by persons having ADEs with a drug. Taking such a drug is unsafe for this group of persons. For example, as for “the drug A is contraindicated to pregnant women”, the “pregnant women” is the population factor of drug A.

According to an embodiment of the present invention, all ADE triggering factors can be substantially covered by dividing contributor factors into allergy factors, disease factors, medication factors, clinical operation factors, and population factors. Certainly, it is not excluded in the method for prompting medication safety that only some contributor factors are taken into account. In such a method, only some aspects of medication safety are concerned.

At S320, for each of the at least one contributor factor of the drug, according to the statement in the drug specification of the drug, a binding relationship between the drug and the contributor factor and the temporal interval are determined by text recognition as unsafe information corresponding to the contributor factor.

The binding relationship between the drug and the contributor factor indicates the binding type thereof and the binding point. As described above, the binding point is a starting point with respect to the temporal interval and the temporal interval can be bound to one of the drug and the contributor factor. As described below, since objects to which temporal intervals are bound can be different, the binding types can be different. Taking drug A and contributor factor X as an example, the binding type indicated by the binding relationship between the drug and the contributor factor is described below.

The binding relationship between drug A and contributor factor X can be categorized into one of four binding types. The first binding type is used to indicate that the use of drug A is unsafe as long as contributor factor X existed in history. For example, if drug A is contraindicated for persons allergic to component C, the binding relationship between component C and drug A is the first binding type. The second binding type is used to indicate that the temporal interval determined from the drug specification after one of drug A and the contributor factor X occurs is an unsafe duration, in which the other one of drug A and the contributor factor X should not occur. For example, if drug A is not allowed to be taken within three months after taking drug B, the binding relationship between drug B and drug A is the second binding type. The third binding type is used to indicate that the temporal interval determined from the drug specification before one of drug A and the contributor factor X occurs is an unsafe duration, in which the other one of drug A and the contributor factor X should not occur. For example, if drug D is not allowed to be taken within one month before taking drug A, the binding relationship between drug A and drug D is the third binding type. The fourth binding type is used to indicate that drug A and the contributor factor X should not occur concurrently. For example, if the drug A is contraindicated to pregnant women, the binding relationship between the pregnant women and drug A is the fourth binding type.

According to an embodiment of the present invention, in the cases of the first and the fourth binding types, the binding point can be either the drug or the contributor factor, which is unrelated to the determination of the unsafe time interval, as described in detail below. In the cases of the second and the third binding types, one of the drug and the contributor factor can be selected as the binding point. Because the binding point can be changed for the second and the third binding types, the second binding type and the third binding type are exchangeable with each other. This depends on whether the temporal interval related to the unsafe duration starts from the drug or the contributor factor (that is, depending on whether the binding point is the drug or the contributor factor). For example, for the case that drug D is not allowed to be taken within one month before taking drug A, if the temporal interval “one month” is with respect to drug A, the binding relationship is the third binding type. If the temporal interval “one month” is with respect to drug D, the binding relationship is the second binding type (that is, drug A is not allowed to be taken within one month after taking drug D). In some embodiments of the present invention, such a conversion can be realized to fix the binding point to the contributor factor constantly. In other embodiments of the present invention, instead of such a conversion, the binding point can be determined directly according the statement of the drug specification and then the binding type can be determined in combination with the temporal interval.

According to an embodiment of the present invention, if the contributor factor X is the allergy factor in the allergy factor template, the binding type between drug A and the contributor factor X can be determined as the first binding type. If the contributor factor X is the population factor in the population factor template, the binding type between drug A and the contributor factor X can be determined as the fourth binding type. If the contributor factor X is one of the disease factor in the disease factor template, the medication factor in the medication factor template, and the clinical operation factor in the clinical operation factor template the binding type between drug A and the contributor factor X can be determined as one of the first binding type to the fourth binding type according to the statement of the drug specification.

Specifically, in the case that contributor factor X is one of the disease factor in the disease factor template, the medication factor in the medication factor template, and the clinical operation factor in the clinical operation factor template, if there is a temporal indicator indicating a temporal interval for contributor factor X in the drug specification, the temporal indictor is used to extract the temporal interval during which an ADE between the contributor factor X and drug A can occur and the binding relationship between the contributor factor X and drug A. For example, as for “two and a half months before a heart bypass operation”, the term “before” is the temporal indicator, the followed “heart bypass operation” is the extracted contributor factor, and the preceding “two and a half month” is the temporal interval during which an ADE can occur due to the contributor factor X and drug A. The binding relationship is the third type if the binding point is bound to the contributor factor. If there is no such temporal indicator indicating a temporal interval for the contributor factor X in the drug specification, the temporal interval during which an ADE can occur between the contributor factor X and drug A and the binding relationship can be derived from empirical data. Such empirical data can be stored in an experience database and can represent an effective duration during which a contributor factor effects. The effective duration of the contributor factor can represent that if the contributor factor occurs, within how long a period of time, there is a risk that the contributor factor can lead to an ADE with a certain drug.

For example, assume that component E is effective for about one month after entering a human body and component F is in conflict with component E. If a patient has taken drug EE having the component E, drug FF containing the component F can only be taken by the patient at least one month later. Thus, if the drug specification merely mentions that drug FF is not allowed to be taken by a person who is taking drug EE, by querying related information in the experience database, it can be determined that drug FF is not allowed to be taken within one month after taking drug EE and then the temporal interval and the binding relationship can be obtained accordingly. More particularly, if the contributor factor X is a chronic disease, in the case of lacking any temporal information, it can be determined that the binding relationship between drug A and contributor factor X is the first binding type. If the contributor factor X is not a chronic disease, in the case of lacking any temporal information, it can be determined that the binding relationship between drug A and contributor factor X is the fourth binding type. The experience database can be produced through entering empirical data by professionals, doctors, etc.

In the table 500 shown in FIG. 5, an example of a specific drug specification of drug A is shown, with binding types, binding points, and temporal intervals corresponding to respective contributor factors obtained by pre-processing the specific drug specification. The meanings of each field and contents have been described above, which is not being repeated herein for concision.

According to the identifier information of drug A stored in the treatment information database shown in FIG. 4, all records related to drug A can be extracted from the drug information data shown in FIG. 5. In combination with the execution time of drug

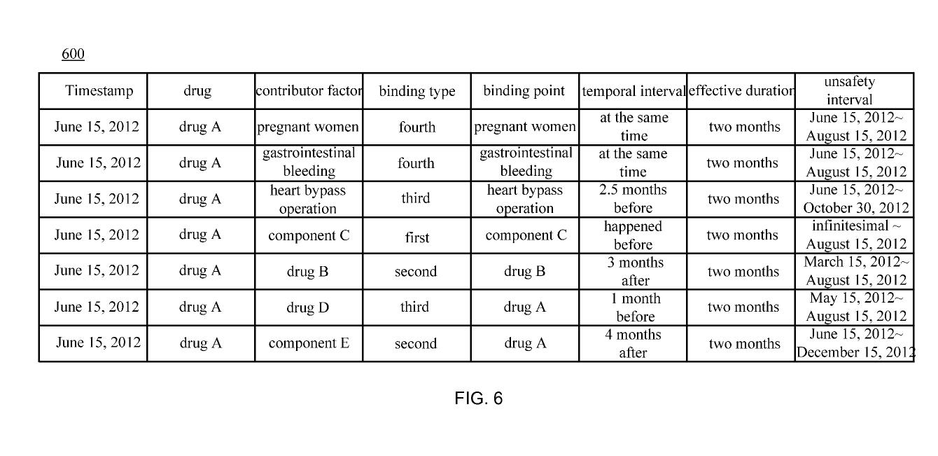

A shown in FIG. 4, table 600 shown in FIG. 6 can be obtained. In addition to the fields in table 400 and table 500 that are combined in table 600, there is also an unsafe time interval field. The unsafe time interval field represents that if a corresponding contributor factor occurs within the stored unsafe time interval, an ADE can be caused. The determination of the unsafe time interval is particularly described at S230′. Further, table 600 can further include other fields, such as a comment field, a drug manufacturer field, etc.

Because only drug A in the table 400 has been taken (drug A is a prescribed drug and drug B is a drug to be prescribed, which is not formally listed in table 400, but is recorded therein for a better understanding), only the records about drug A can be extracted from the drug information database and stored in table 600. However, those skilled in the art understand that, although only information about drug A is shown in table 600, if drugs that are being taken by the patient increase in table 400, drug information records extracted from table 500 also increase and records in table 600 increase accordingly.

Further, as shown in FIG. 3, at S210′, identifier information and execution times of a prescribed drug are extracted from the treatment information database. At S220′, according to the identifier information of the prescribed drug, records related to the prescribed drug are extracted from the drug information database established through S310 and S320. Steps S210′ and S220′ are substantially the same as steps S210 and S220.

At S230′, according to the execution time of the prescribed drug extracted at S210′ and the binding relationships contained in unsafe information corresponding to the contributor factors of the prescribed drug extracted at S220′, unsafe time intervals corresponding to the contributor factors of the prescribed drug are determined. S230 is substantially the same as S230′. How to obtain the unsafe time interval is particularly described below.

In the case that the binding relationship between drug A and the contributor factor X is the first binding type, the unsafe time interval is at least an interval from an arbitrary past time to the ending time of taking drug A. For example, in the example shown in FIG. 6, because the binding relationship between drug A and component C is the first binding type, the unsafe time interval corresponding to the record of component C is at least an interval from an arbitrary past time to Aug. 15, 2012 (Jun. 15, 2012+2 months).

In the case that the binding relationship between drug A and the contributor factor X is the second binding type, if the temporal interval contained in the unsafe information corresponding to the contributor factor X is after the occurrence of drug A, the unsafe time interval is at least an interval from the beginning time of taking drug A to the sum of the ending time of taking drug A and this temporal interval. For example, in the example shown in FIG. 6, because the binding relationship between drug A and component E is the second binding type and the binding point of the temporal interval is drug A, the unsafe time interval corresponding to the record of component E is at least an interval from Jun. 15, 2012 to Dec. 15, 2012 (Jun. 15, 2012+2 month+4 months). Further, if the temporal interval contained in the unsafe information corresponding to the contributor factor X is after the occurrence of the contributor factor X, the unsafe time interval is at least an interval from the difference between the beginning time of taking drug A and this temporal interval to the ending time of taking drug A. For example, in the example of FIG. 6, because the binding relationship between drug A and drug B is the second binding type and the binding point of the temporal interval is drug B, the unsafe time interval corresponding to the record of drug B is at least an interval from Mar. 15, 2012 (Jun. 15, 2012−3 months) to Aug. 15, 2012 (Jun. 15, 2012+2 months).

In the case that the binding relationship between drug A and the contributor factor X is the third binding type, if the temporal interval contained in the unsafe information corresponding to the contributor factor X is before the occurrence of drug A, the unsafe time interval is at least an interval from the difference between the beginning time of taking drug A and this temporal interval to the ending time of taking drug A. For example, in the example of FIG. 6, because the binding relationship between drug A and drug D is the third binding type and the binding point of the temporal interval is drug A, the unsafe time interval corresponding to the record of drug D is an interval from May 15, 2012 (Jun. 15, 2012−1 month) to Aug. 15, 2012 (Jun. 15, 2012+2 months). Further, if the temporal interval contained in the unsafe information corresponding to the contributor factor X is before the occurrence of the contributor factor X, the unsafe time interval is at least an interval from the beginning time of taking drug A to the sum of the ending time of taking drug A and this temporal interval. For example, in the example of FIG. 6, because the binding relationship between drug A and the heart stent implantation is the third binding type and the binding point of the temporal interval is the heart bypass operation, the unsafe time interval corresponding to the record of the heart bypass operation is an interval from Jun. 15, 2012 to Oct. 30, 2012 (Jun. 15, 2012+2 months+2.5 months).

In the case that the binding relationship between drug A and the contributor factor X is the fourth binding type, the unsafe time interval corresponding to the contributor factor X is at least an interval from the beginning time of taking drug A to the ending time of taking drug A. For example, in the example in FIG. 6, because the binding relationship between drug A and pregnant women and the binding relationship between drug A and gastrointestinal bleeding are both the fourth binding type, each of the unsafe time interval corresponding to pregnant women and the unsafe time interval corresponding to gastrointestinal bleeding is an interval from Jun. 15, 2012 to Aug. 15, 2012.

From the following expressions, the calculation of the unsafe time interval can become clearer. In the following expressions, the unsafe time interval is represented by usts (UnSafety Temporal State) (In order to further improve safety, the unsafe time interval determined by the system can be larger than usts), the beginning time of taking a prescribed drug is represented by dbt (Drug-taking Beginning Time), the ending time of taking the prescribed drug is represented by det (Drug-taking Ending Time) (det can be equal to the sum of dbt and an effective time), and the temporal interval contained in the unsafe information of the contributor factor is represented by ti (Temporal Interval).

In the case of the first binding type, no matter whether the binding point is bound to the drug or the contributor factor or there is no binding point, usts=(infinitesimal, det], wherein the infinitesimal can be a time that cannot happen any more.

In the case of the second binding type, if the binding point is the drug, usts=[dbt, det+ti]. If the binding point is the contributor factor, usts=[dbt-ti, det].

In the case of the third binding type, if the binding point is the drug, usts=[dbe-ti, det]. If the binding point is the contributor factor, usts=[dbt, det+ti].

In the case of the fourth binding type, no matter whether the binding point is bound to the drug or the contributor factor or there is no binding point, usts=[dbt, det].

According to an embodiment of the present invention, table 600 can be stored in a drug use database. Logically, there can be multiple tables like table 600 stored in the drug use database, each for a corresponding patient, representing drugs being taken by the patient as well as potential ADEs caused by those drugs and corresponding unsafe time intervals. By maintaining such a table as table 600 for each patient, drug-taking status can be traced for the patient and some information can be prevented from being neglected in new treatments.

After the unsafe time intervals are determined, step S250′ which is substantially the same as step S250, can be executed before which S240′ is executed.

At S240′, identifier information and execution time of a target factor are extracted from the treatment information database. This step is substantially the same as S240. When a doctor intends to prescribe a new drug, prepare a new clinical operation, or assess the safety of a drug or a clinical operation, S240′ can be executed. There is no limitation on the execution order of S240′ and all the steps except for S250′ in method 300.

At S250′, in response to the identifier information of the target factor extracted at S240′ matching with a contributor factor of the prescribed drug in, for example, table 600 and at least a part of the execution time of the target factor falling within the unsafe time interval corresponding to the matched contributor factor that is calculated at S230′, advice on medication safety is provided.

For instance, assume that table 400 of FIG. 4 is treatment information specific to patient X and table 400 only has treatment records about drug A and the hemodialysis treatment currently stored therein, which represent that patient X has started taking drug A and received the hemodialysis treatment. By using the above technique, in combination with the drug information database, records about drug A can be extracted (that is, records shown in table 500 of FIG. 5). By combining table 400 and table 500 and calculating respective unsafe time intervals, the form as table 600 of FIG. 6 can be obtained, wherein table 600 is directed to patient X.

Assume that the current time is Aug. 10, 2012, and a doctor intends to prescribe drug B to patient X and instruct patient X to take this drug on this day. Treatment information about drug B can be stored in table 400 temporarily in advance, as shown in FIG. 4. Next, drug B is matched against the contributor factor field in table 600. After drug B is matched in the contributor factor field, the beginning time of taking drug B (Aug. 10, 2012) is compared with the unsafe time interval corresponding to drug B listed in table 600. As a result, it can be found that the beginning time of taking drug B falls within the unsafe time interval, which means that taking drug B can cause an ADE and thus advice on medication safety is provided.

According to an embodiment of the present invention, prompting medication safety can include at least one of: prompting that the target factor can cause an ADE; prompting to modify the execution time of the target factor; and updating the execution time of the target factor to avoid the occurrence of the ADE.

As for the particular example above, when it is found that drug B can lead to an ADE: a prompt can be provided through popping out a dialog box, sending an alert, and so on to indicate that drug B can cause an ADE; or the doctor can be prompted to modify the beginning time of taking drug B (for example, to set the beginning time of taking drug B to at least after Aug. 15, 2012 and so on); or the beginning time of taking drug B can be automatically updated (for example, the beginning time of taking drug B can be delayed to Aug. 20, 2012 from Aug. 10, 2012).

After it is determined that the beginning time of taking drug B cannot cause an ADE, drug B can be formally recorded in table 400 of the treatment information database as a prescribed drug that has been taken.

However, if the current time is Sep. 1, 2012 and drug B is ordered to be taken on this day, since the date does not fall within the corresponding unsafe time interval of drug B in table 600, taking drug B cannot lead to an ADE. If the drug to be prescribed by the doctor is not drug B and does not have a matched contributor factor in table 600, no matter when the patient starts taking the drug to be prescribed, no ADE can occur.

In the case that the drug to be prescribed cannot lead to an ADE, records related to the drug to be prescribed can be extracted from the drug information database according to the identifier information of the drug to be prescribed and are stored in the drug use database in association with the execution time of the drug to be prescribed. As for the particular example above, if the drug to be prescribed is drug B and the beginning time of taking drug B is later than Aug. 15, 2012, the records related to drug B that are obtained by a pre-process performed on the drug specification of drug B can be found out from the drug information database according to the identifier information of drug B. Then, in combination with the execution time of drug B stored in the treatment information database, unsafe time intervals of drug B incurred by its respective contributor factors are produced and are added into table 600 along with the records of drug B in table 400 and table 500.

According to an embodiment of the present invention, in response to an unsafe time interval expiring, records corresponding to the expired unsafe time interval of the prescribed drug are deleted from the drug use database. As for the particular example above, if the current time is Sep. 1, 2012, because the time exceeds the unsafe time intervals of multiple records in table 600, those records having expired unsafe time intervals are deleted and only records related to the heart bypass operation and component E are retained.

Through adding records into and deleting records from the drug use database (for example, table 600), the tracing of drug use can be realized and ADEs caused by drugs that are taken by a patient can be monitored. Because the calculated unsafe time intervals in the drug use database reflect the past, current, and future status of a patient, by analyzing a currently present target factor or a target factor to be present in the future from a different time, ADEs that can occur currently or in the future can be obtained respectively, so that medication safety can be realized in a more convenient, efficient, and accurate manner.

Further, it should be noted that the treatment information database, the drug information database, and the drug use database described above are logically defined databases and can be different storage spaces divided according to their effects and functions. These databases can be physically located in a same database or can be separated into different databases. For example, the treatment information database and the drug use database can be located in the HER, while the drug information database can be located in another separate mass storage repository.

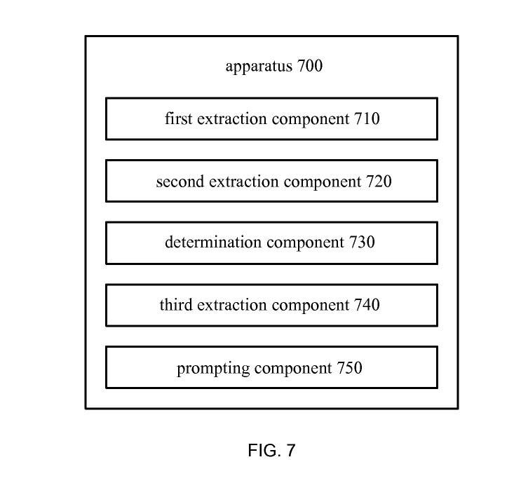

A method for prompting medication safety according to an embodiment of the present invention has been described above. Next, the block diagrams of an apparatus for prompting medication safety according to an embodiment of the present invention and a hospital information system containing such an apparatus is described with reference to FIG. 7 to FIG. 9.

An apparatus 700 for prompting medication safety according to an embodiment of the present invention as shown in FIG. 7 includes a first extraction component 710, a second extraction component 720, a determination component 730, a third extraction component 740, and a prompting component 750. The first extraction component 710 can be configured to extract identifier information and execution time of a prescribed drug from a treatment information database for storing treatment information. The second extraction component 720 can be configured to, according to the identifier information of the prescribed drug, extract a record related to the prescribed drug from a drug information database for storing drug information, the record including at least one contributor factor of the prescribed drug and unsafety information corresponding to the at least one contributor factor. The determination component 730 can be configured to, for each of the at least one contributor factor of the prescribed drug, according to the execution time of the prescribed drug and the unsafety information corresponding to the contributor factor, determine an unsafe time interval corresponding to the contributor factor of the prescribed drug. The third extraction component 740 can be configured to extract identifier information and execution time of a target factor from the treatment information database. The prompting component 750 can be configured to, in response to the target factor matching with a contributor factor of the prescribed drug and at least a part of the execution time of the target factor falling within the unsafe time interval corresponding to the matched contributor factor, prompt medication safety.

Reference can be made to corresponding description in the above method 200 for the above operations and/or functions of the first extraction component 710, the second extraction component 720, the determination component 730, the third extraction component 740, and the prompting component 750, which is not repeated herein to avoid repetition.

According to the above apparatus for prompting medication safety, by utilizing the treatment information database in conjunction with the drug information database, internal data processing can be optimized, prescribed drugs can be found out thoroughly for a patient and respective unsafe time intervals corresponding to those prescribed drugs can be determined, so that the influence of the prescribed drugs can be determined completely and efficiently. By comparing the execution time of a target factor with the unsafe time intervals, a patient can be prevented from performing events which can cause ADEs within the unsafe time intervals and, thus, medication safety can be improved.

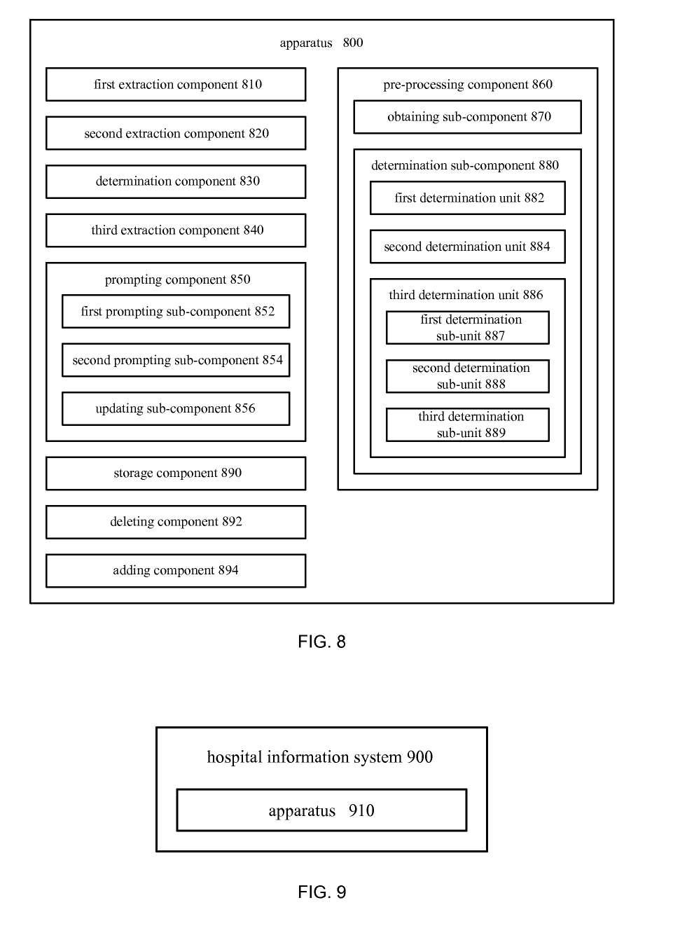

FIG. 8 shows a structure block diagram of another apparatus 800 for prompting medication safety according to an embodiment of the present invention. A first extraction component 810, a second extraction component 820, a determination component 830, a third extraction component 840, and a prompting component 850 included in the apparatus 800 are substantially the same as the first extraction component 710, the second extraction component 720, the determination component 730, the third extraction component 740, and the prompting component 750, respectively.

According to an embodiment of the present invention, the apparatus 800 can further include a pre-processing component 860. The pre-processing component 860 can be configured to pre-process a drug specification of a drug to obtain at least one contributor factor of the drug and unsafety information corresponding to the at least one contributor factor of the drug and storing the identifier information of the drug, the contributor factor of the drug, and the unsafety information corresponding to the contributor factor of the drug in the drug information database in association as a record related to the drug.

According to another embodiment of the present invention, the pre-processing component 860 can include an obtaining sub-component 870 and a determination sub-component 880. The obtaining sub-component 870 can be configured to, according to predefined contributor factor templates, obtain the at least one contributor factor of the drug from the drug specification of the drug, the contributor factor templates including at least one of an allergy factor template, a disease factor template, a medication factor template, a clinical operation factor template, and a population factor template. The determination sub-component 880 can be configured to determine, for each of the at least one contributor factor, according to the statement of the drug specification of the drug, a binding relationship between the drug and the contributor factor and a temporal interval as the unsafety information corresponding to the contributor factor by character recognition, wherein, the binding relationship is categorized into: a first binding type for indicating that the use of the drug is unsafe as long as the contributor factor occurred in history; a second binding type for indicating that the temporal interval after the occurrence of one of the drug and the contributor factor is an unsafe duration, during which the other one of the drug and the contributor factor should not occur; a third binding type for indicating that the temporal interval before the occurrence of one of the drug and the contributor factor is an unsafe duration, during which the other one of the drug and the contributor factor should not occur; and a fourth binding type for indicating that the drug and the contributor factor should not occur concurrently.

According to an embodiment of the present invention, the determination sub-component 880 can include at least one of a first determination unit 882, a second determination unit 884, and a third determination unit 886. The first determination unit 882 can be configured to determine that the binding relationship between the drug and the contributor factor is the first binding type, if the contributor factor is an allergy factor in the allergy factor template. The second determination unit 884 can be configured to determine that the binding relationship between the drug and the contributor factor is the fourth binding type, if the contributor factor is a population factor in the population factor template. The third determination unit 886 can be configured to determine that the binding relationship between the drug and the contributor factor is one of the first binding type to the fourth binding type according to the statement of the drug specification, if the contributor factor is one of a disease factor in the disease factor template, a medication factor in the medication factor template, and a clinical operation factor in the clinical operation factor template.

According to an embodiment of the present invention, the third determination unit 886 can include a first determination sub-unit 887, a second determination sub-unit 888, and a third determination sub-unit 889. The first determination sub-unit 887 can be configured to determine whether there is temporal information about the contributor factor in the drug specification. The second determination sub-unit 888 can be configured to determine that the binding relationship between the drug and the contributor factor is one of the first binding type to the fourth binding type by character recognition, if there is the temporal information. The third determination sub-unit 889 can be configured to determine that the binding relationship between the drug and the contributor factor is one of the first binding type to the fourth binding type by retrieving an experience database for storing effective durations of contributor factors if there is not the temporal information.

According to an embodiment of the present invention, the determination component 830 can be specifically configured to, according to the execution time of the prescribed drug and the binding relationship contained in the unsafety information corresponding to the contributor factor, determining an unsafe time interval corresponding to the contributor factor of the prescribed drug as follows: in the case of the first binding type, determining that the unsafe time interval is at least an interval from an arbitrary past time to the ending time of taking the prescribed drug; in the case of the second binding type, if the temporal interval contained in the unsafety information is after the occurrence of the prescribed drug, determining that the unsafe time interval is at least an interval from the beginning time of taking the prescribed drug to the sum of the ending time of taking the prescribed drug and the temporal interval or, if the temporal interval contained in the unsafety information is after the occurrence of the contributor factor, determining that the unsafe time interval is at least an interval from the difference between the beginning time of taking the prescribed drug and the temporal interval to the ending time of taking the prescribed drug; in the case of the third binding type, if the temporal interval contained in the unsafety information is before the occurrence of the prescribed drug, determining that the unsafe time interval is at least an interval from the difference between the beginning time of taking the prescribed drug and the temporal interval to the ending time of taking the prescribed drug or, if the temporal interval contained in the unsafety information is before the occurrence of the contributor factor, determining that the unsafe time interval is at least an interval from the beginning time of taking the prescribed drug to the sum of the ending time of taking the prescribed drug and the temporal interval; or in the case of the fourth binding type, determining that the unsafe time interval is at least an interval from the beginning time of taking the prescribed drug to the ending time of taking the prescribed drug.

According to an embodiment of the present invention, the apparatus 800 can further include a storage component 890. The storage component 890 can be configured to store the extracted record related to the prescribed drug and the determined unsafe time interval in a drug use database in association. In such a case, the apparatus 800 can further include a deleting component 892. The deleting component 892 can be configured to, in response to an unsafe time interval expiring, delete the record corresponding to the expired unsafe time interval of the prescribed drug from the drug use database. Further, the apparatus 800 can include an adding component 894. The adding component 894 can be configured to, in response to the identifier information of the target factor not matching with a contributor factor of the prescribed drug or the execution time of the target factor not falling within the unsafe time interval corresponding to the contributor factor of the prescribed drug at all, in the case that the target factor is a drug to be prescribed, extract a record related to the target factor from the drug information database according to the identifier information of the target factor and adding the record into the drug use database in combination with the execution time of the target factor.

According to an embodiment of the present invention, the prompting component 850 can include at least one of a first prompting sub-component 852, a second prompting sub-component 854, and an updating sub-component 856. The first prompting sub-component 852 can be configured to prompt that the target factor can cause an ADE. The second prompting sub-component 854 can be configured to prompt to modify the execution time of the target factor. The updating sub-component 856 can be configured to update the execution time of the target factor to avoid the occurrence of an ADE.

Various components, sub-components, units, and sub-units in FIG. 8 can be realized by a processor and reference can be made to the method 300 and related tables in FIG. 4 to FIG. 6 for the above operations and/or functions thereof, which is not repeated herein to avoid repetition.

By performing the pre-process on the drug specification, records in the drug information database can be automatically produced in an easy and efficient manner. Further, the drug information database can be expanded continuously according to new drug specifications and, thus, more complete and comprehensive information is acquired. Compared to the prior art in which ADE knowledge is only for reading, ADE knowledge can be exploited in two directions. In addition, tedious and low efficient information entering can be avoided and errors caused by information entering can be prevented. Through adding records into and deleting records from the drug use database with the adding component and the deleting component, the tracing of drug use can be realized and ADEs caused by drugs that are taken by a patient can be monitored. Because the calculated unsafe time interval in the drug use database reflect the past, current, and future status of a patient, by analyzing a currently present target factor or a target factor to be present in the future from different time, ADEs that can occur currently or in the future can be obtained respectively, so that medication safety can be realized in a more convenient, efficient, and accurate manner.

The hospital information system 900 shown in FIG. 9 can include an apparatus 910. The apparatus 910 can be the apparatus 700 or the apparatus 800 described above. With the processing techniques involved in the apparatus 700 or the apparatus 800, by utilizing the treatment information database in association with the drug information database, internal data process can be optimized and the process speed and efficiency of obtaining medication safety information can be improved. Compared to the standalone database searching and static matching approach in the prior art, with associated search for databases as well as the dynamic establishment and record adding/ deleting for the drug use database in embodiments of the present invention, system process resources can be saved.

The flowchart and block diagrams in the Figures illustrate the architecture, functionality, and operation of possible implementations of systems, methods and computer program products according to various embodiments of the present invention. In this regard, each block in the flowchart or block diagrams can represent a module, segment, or portion of code, which includes one or more executable instructions for implementing the specified logical function(s). It can also be noted that, in some alternative implementations, the functions noted in the block can occur out of the order noted in the figures. For example, two blocks shown in succession can, in fact, be executed substantially concurrently, or the blocks can sometimes be executed in the reverse order, depending upon the functionality involved. It can also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The descriptions of the various embodiments of the present invention have been presented for purposes of illustration, but are not intended to be exhaustive or limited to the embodiments disclosed. Many modifications and variations can be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer implemented method for prompting medication safety information, wherein the computer includes a processor communicatively coupled to a memory, the method comprising the steps of:
extracting identifier information and execution time of a prescribed drug from a treatment information database for storing treatment information;
according to the identifier information of the prescribed drug, extracting a record related to the prescribed drug from a drug information database, the record comprising at least one contributor factor of the prescribed drug and unsafety information corresponding to the at least one contributor factor;
for each of the at least one contributor factor of the prescribed drug, according to the execution time of the prescribed drug and the unsafety information corresponding to the contributor factor, determining an unsafe time interval corresponding to the contributor factor of the prescribed drug;
extracting identifier information and execution time of a target factor from the treatment information database; and
in response to the target factor matching with a contributor factor of the prescribed drug and at least a part of the execution time of the target factor falling within the unsafe time interval corresponding to the matched contributor factor, prompting medication safety information.

2. The computer implemented method for prompting medication safety information according to claim 1, further comprising the steps of:
pre-processing a drug specification of a drug to obtain at least one contributor factor of the drug and unsafety information corresponding to the at least one contributor factor of the drug; and
storing the identifier information of the drug, the contributor factor of the drug, and the unsafety information corresponding to the contributor factor of the drug in the drug information database in association as a record related to the drug.

3. The computer implemented method for prompting medication safety information according to claim 2, wherein the pre-processing comprises:
according to predefined contributor factor templates, obtaining the at least one contributor factor of the drug from the drug specification of the drug, wherein the contributor factor templates comprises at least one of an allergy factor template, a disease factor template, a medication factor template, a clinical operation factor template, and a population factor template; and
for each of the at least one contributor factor, according to the statement of the drug specification of the drug, determining a binding relationship between the drug and the contributor factor and a temporal interval as the unsafety information corresponding to the contributor factor by character recognition, wherein, the binding relationship is categorized into:
a first binding type for indicating that the use of the drug is unsafe as long as the contributor factor occurred in history;
a second binding type for indicating that the temporal interval after the occurrence of one of the drug and the contributor factor is an unsafe duration, wherein during the temporal interval the other one of the drug and the contributor factor should not occur;
a third binding type for indicating that the temporal interval before the occurrence of one of the drug and the contributor factor is an unsafe duration, wherein during the temporal interval the other one of the drug and the contributor factor should not occur; and
a fourth binding type for indicating that the drug and the contributor factor should not occur concurrently.

4. The computer implemented method for prompting medication safety information according to claim 3, wherein determining a binding relationship between the drug and the contributor factor comprises:
if the contributor factor is an allergy factor in the allergy factor template, determining that the binding relationship between the drug and the contributor factor is the first binding type;
if the contributor factor is a population factor in the population factor template, determining that the binding relationship between the drug and the contributor factor is the fourth binding type; or
if the contributor factor is one of a disease factor in the disease factor template, a medication factor in the medication factor template, and a clinical operation factor in the clinical operation factor template, determining that the binding relationship between the drug and the contributor factor is one of the first binding type to the fourth binding type according to the statement of the drug specification.

5. The computer implemented method for prompting medication safety information according to claim 4, wherein determining that the binding relationship between the drug and the contributor factor is one of the first binding type to the fourth binding type comprises:
determining whether there is temporal information about the contributor factor in the drug specification; and
if there is the temporal information, determining that the binding relationship between the drug and the contributor factor is one of the first binding type to the fourth binding type by character recognition; or
if there is not the temporal information, determining that the binding relationship between the drug and the contributor factor is one of the first binding type to the fourth binding type by retrieving an experience database for storing effective durations of contributor factors.

6. The computer implemented method for prompting medication safety information according to claim 3, wherein according to the execution time of the prescribed drug and the unsafety information corresponding to the contributor factor, determining an unsafe time interval corresponding to the contributor factor of the prescribed drug comprises:
in the case of the first binding type, determining that the unsafe time interval is at least an interval from an arbitrary past time to the ending time of taking the prescribed drug;
in the case of the second binding type:
if the temporal interval contained in the unsafety information is after the occurrence of the prescribed drug, determining that the unsafe time interval is at least an interval from the beginning time of taking the prescribed drug to the sum of the ending time of taking the prescribed drug and the temporal interval; or
if the temporal interval contained in the unsafety information is after the occurrence of the contributor factor, determining that the unsafe time interval is at least an interval from the difference between the beginning time of taking the prescribed drug and the temporal interval to the ending time of taking the prescribed drug;
in the case of the third binding type:
if the temporal interval contained in the unsafety information is before the occurrence of the prescribed drug, determining that the unsafe time interval is at least an interval from the difference between the beginning time of taking the prescribed drug and the temporal interval to the ending time of taking the prescribed drug; or
if the temporal interval contained in the unsafety information is before the occurrence of the contributor factor, determining that the unsafe time interval is at least an interval from the beginning time of taking the prescribed drug to the sum of the ending time of taking the prescribed drug and the temporal interval; or
in the case of the fourth binding type, determining that the unsafe time interval is at least an interval from the beginning time of taking the prescribed drug to the ending time of taking the prescribed drug.

7. The computer implemented method for prompting medication safety information according to claim 1, the method further comprising the steps of:
storing the extracted record related to the prescribed drug and the determined unsafe time interval in a drug use database in association; and
in response to an unsafe time interval expiring, deleting the record corresponding to the expired unsafe time interval of the prescribed drug from the drug use database.

8. The computer implemented method for prompting medication safety information according to claim 7, the method further comprising the steps of:
in response to the identifier information of the target factor not matching with a contributor factor of the prescribed drug; or
the execution time of the target factor not falling within the unsafe time interval corresponding to the contributor factor of the prescribed drug at all; and
in the case that the target factor is a drug to be prescribed:
extracting a record related to the target factor from the drug information database according to the identifier information of the target factor; and
adding the record into the drug use database in combination with the execution time of the target factor.

9. The computer implemented method for prompting medication safety information according to claim 1, wherein prompting medication safety comprises at least one of:
prompting that the target factor can cause an ADE;
prompting to modify the execution time of the target factor; and
updating the execution time of the target factor to avoid the occurrence of an ADE.

10. A computer readable storage medium tangibly embodying a computer readable non-transitory program code having computer readable instructions which, when implemented, cause a computer to carry out the steps of a method for prompting medication safety information according to claim 1.

11. An apparatus for prompting medication safety information, wherein the apparatus includes a processor communicatively coupled to a memory, the apparatus comprising:
a first extraction component configured to extract identifier information and execution time of a prescribed drug from a treatment information database;
a second extraction component configured to, according to the identifier information of the prescribed drug, extract a record related to the prescribed drug from a drug information database, wherein the record comprises at least one contributor factor of the prescribed drug and unsafety information corresponding to the at least one contributor factor;
a determination component configured to, for each of the at least one contributor factor of the prescribed drug and according to the execution time of the prescribed drug and the unsafety information corresponding to the contributor factor, determine an unsafe time interval corresponding to the contributor factor of the prescribed drug;
a third extraction component configured to extract identifier information and execution time of a target factor from the treatment information database; and
a prompting component configured to, in response to the target factor matching with a contributor factor of the prescribed drug and at least a part of the execution time of the target factor falling within the unsafe time interval corresponding to the matched contributor factor, prompt medication safety information.

12. The apparatus for prompting medication safety information according to claim 11, the apparatus further comprising:
a pre-processing component configured to pre-process a drug specification of a drug to obtain at least one contributor factor of the drug and unsafety information corresponding to the at least one contributor factor of the drug; and
a storing component configured to store the identifier information of the drug, the contributor factor of the drug, and the unsafety information corresponding to the contributor factor of the drug in the drug information database in association as a record related to the drug.

13. The apparatus for prompting medication safety information according to claim 12, wherein the pre-processing component comprises:
an obtaining sub-component configured to, according to predefined contributor factor templates, obtain the at least one contributor factor of the drug from the drug specification of the drug, wherein the contributor factor templates comprises at least one of an allergy factor template, a disease factor template, a medication factor template, a clinical operation factor template, and a population factor template; and
a determination sub-component configured to determine, for each of the at least one contributor factor and according to the statement of the drug specification of the drug, a binding relationship between the drug and the contributor factor and a temporal interval as the unsafety information corresponding to the contributor factor by character recognition, wherein the binding relationship is categorized into:
a first binding type for indicating that the use of the drug is unsafe as long as the contributor factor occurred in history;
a second binding type for indicating that the temporal interval after the occurrence of one of the drug and the contributor factor is an unsafe duration, wherein during the temporal interval the other one of the drug and the contributor factor should not occur;
a third binding type for indicating that the temporal interval before the occurrence of one of the drug and the contributor factor is an unsafe duration, wherein during the temporal interval the other one of the drug and the contributor factor should not occur; and
a fourth binding type for indicating that the drug and the contributor factor should not occur concurrently.

14. The apparatus for prompting medication safety information according to claim 13, wherein the determination sub-component comprises:
a first determination unit configured to determine that the binding relationship between the drug and the contributor factor is the first binding type if the contributor factor is an allergy factor in the allergy factor template;
a second determination unit configured to determine that the binding relationship between the drug and the contributor factor is the fourth binding type if the contributor factor is a population factor in the population factor template; or
a third determination unit configured to determine that the binding relationship between the drug and the contributor factor is one of the first binding type to the fourth binding type according to the statement of the drug specification if the contributor factor is one of a disease factor in the disease factor template, a medication factor in the medication factor template, and a clinical operation factor in the clinical operation factor template.

15. The apparatus for prompting medication safety information according to claim 14, wherein the third determination unit comprises:
a first determination sub-unit configured to determine whether there is temporal information about the contributor factor in the drug specification;
a second determination sub-unit configured to determine that the binding relationship between the drug and the contributor factor is one of the first binding type to the fourth binding type by character recognition if there is the temporal information;
a third determination sub-unit, configured to determine that the binding relationship between the drug and the contributor factor is one of the first binding type to the fourth binding type by retrieving an experience database for storing effective durations of contributor factors if there is not the temporal information.

16. The apparatus for prompting medication safety information according to claim 13, wherein the determination component is configured to, according to the execution time of the prescribed drug and the binding relationship contained in the unsafety information corresponding to the contributor factor, determine an unsafe time interval corresponding to the contributor factor of the prescribed drug as follows:
in the case of the first binding type, determining that the unsafe time interval is at least an interval from an arbitrary past time to the ending time of taking the prescribed drug;
in the case of the second binding type:
if the temporal interval contained in the unsafety information is after the occurrence of the prescribed drug, determining that the unsafe time interval is at least an interval from the beginning time of taking the prescribed drug to the sum of the ending time of taking the prescribed drug and the temporal interval; or
if the temporal interval contained in the unsafety information is after the occurrence of the contributor factor, determining that the unsafe time interval is at least an interval from the difference between the beginning time of taking the prescribed drug and the temporal interval to the ending time of taking the prescribed drug;
in the case of the third binding type:
if the temporal interval contained in the unsafety information is before the occurrence of the prescribed drug, determining that the unsafe time interval is at least an interval from the difference between the beginning time of taking the prescribed drug and the temporal interval to the ending time of taking the prescribed drug; or
if the temporal interval contained in the unsafety information is before the occurrence of the contributor factor, determining that the unsafe time interval is at least an interval from the beginning time of taking the prescribed drug to the sum of the ending time of taking the prescribed drug and the temporal interval; or
in the case of the fourth binding type, determining that the unsafe time interval is at least an interval from the beginning time of taking the prescribed drug to the ending time of taking the prescribed drug.

17. The apparatus for prompting medication safety information according to claim 11, the apparatus further comprising:
a storage component configured to store the extracted record related to the prescribed drug and the determined unsafe time interval in a drug use database in association; and
a deleting component configured to, in response to an unsafe time interval expiring, delete the record corresponding to the expired unsafe time interval of the prescribed drug from the drug use database.

18. The apparatus for prompting medication safety information according to claim 17, the apparatus further comprising:
an adding component configured to, in response to the identifier information of the target factor not matching with a contributor factor of the prescribed drug or the execution time of the target factor not falling within the unsafe time interval corresponding to the contributor factor of the prescribed drug at all and in the case that the target factor is a drug to be prescribed, extract a record related to the target factor from the drug information database according to the identifier information of the target factor; and
a recording component configured to add the record into the drug use database in combination with the execution time of the target factor.

19. The apparatus for prompting medication safety information according to claim 11, wherein the prompting component comprises at least one of:
a first prompting sub-component configured to prompt that the target factor can cause an ADE;
a second prompting sub-component configured to prompt to modify the execution time of the target factor; and
an updating sub-component configured to update the execution time of the target factor to avoid the occurrence of an ADE.

20. A hospital information system for prompting medication safety information, wherein the hospital information system includes a processor communicatively coupled to a memory, the hospital information system comprising the apparatus according to claim 11.
